(19) United States
(12) Patent Application Publication
(10) Pub. No.: US 2023/0182141 A1
(43) Pub. Date: Jun. 15, 2023

(54) MODULAR TITER PLATE ASSEMBLY

(71) Applicant: TEXAS INSTRUMENTS INCORPORATED, Dallas, TX (US)

(72) Inventors: Sebastian MEIER, Muenchen (DE); Bernhard ZIEGLTRUM, Freising (DE); Marcus ZIMNIK, Regensburg (DE); Bernhard WOLF, Stegen (DE)

(21) Appl. No.: 17/877,610

(22) Filed: Jul. 29, 2022

Related U.S. Application Data
(60) Provisional application No. 63/289,661, filed on Dec. 15, 2021.

(51) Int. Cl. B01L 3/00

(52) U.S. Cl. CPC B01L 3/50855; B01L 3/50857; B01L 2300/0663; B01L 2300/0829

(57) ABSTRACT

A modular titer plate assembly includes a multi-well plate, a sensor assembly, and a mainboard. The multi-well plate includes a two-dimensional array of wells. The sensor assembly is detachably mounted to the multi-well plate. The sensor assembly includes a two-dimensional array of sensors aligned with the two-dimensional array of wells. The mainboard is detachably mounted to the sensor assembly.

### CROSS-REFERENCE TO RELATED APPLICATIONS

This application claims priority to U.S. Provisional Application No. 63/289,661, filed Dec. 15, 2021, entitled “Modular Differential Lab-on-Chip Titer Plate,” the entirety of which is hereby incorporated by reference.

### BACKGROUND

Multi-well test plates, also called micro-titer plates or simply titer plates, are used for assays involving biological or biochemical materials. A titer plate is a plate-shaped structure that includes multiple reaction chambers. The reaction chambers, also called cavities, cups, or wells, are arranged in rows and columns to form a multi-cellular or honeycomb structure. A small amount of a liquid sample is placed in each reaction chamber. During testing, a reaction (e.g., a chemical or biological reaction) takes place, which may be accompanied by a coloration or discoloration of the liquid samples. The color change resulting from the reaction may be monitored optically or electro-optically.

### SUMMARY

In one example, a modular titer plate assembly includes a multi-well plate, a sensor assembly, and a mainboard. The multi-well plate includes a two-dimensional array of wells. The sensor assembly is detachably mounted to the multi-well plate. The sensor assembly includes a two-dimensional array of sensors aligned with the two-dimensional array of wells. The mainboard is detachably mounted to the sensor assembly.

In another example, a modular titer plate assembly includes a multi-well plate. The multi-well plate includes a two-dimensional array of wells. The two-dimensional array of wells includes a row of wells and includes channels. Each channel couples between respective adjacent wells of the row of wells. Each channel is configured to allow liquid to flow between the adjacent wells.

In a further example, a system includes a modular titer plate assembly and a data processor. The modular titer plate assembly includes a multi-well plate, a sensor assembly, and a mainboard. The multi-well plate includes a two-dimensional array of wells. The sensor assembly is detachably mounted to the multi-well plate. The sensor assembly includes a two-dimensional array of sensors aligned with the two-dimensional array of wells. The two-dimensional array of sensors includes at least one of: a pH sensor, a conductivity sensor, an oxygen sensor, or a temperature sensor. The mainboard is detachably mounted to the sensor assembly. The data processor is communicatively coupled to the modular titer plate assembly.

### BRIEF DESCRIPTION OF THE DRAWINGS

FIG. 1 is a perspective view of an example modular titer plate assembly as described herein.

FIG. 2A is a top view of an example multi-well plate of the modular titer plate assembly of FIG. 1.

FIG. 2B is a cross-sectional view of the example multi-well plate of FIG. 2A.

FIG. 2C is an end view of the example multi-well plate of FIGS. 2A and 2B.

FIG. 2D is a bottom view of the example multi-well plate of FIGS. 2A through 2C.

FIG. 3A is a top perspective view of the example multi-well plate of FIGS. 2A through 2E.

FIG. 3B is a bottom perspective view of the example multi-well plate of FIGS. 2A through 2E.

FIG. 4A is an exploded perspective view of an example mainboard and an example sensor assembly of the modular titer plate of FIG. 1.

FIG. 4B is perspective view of a bottom of the example sensor assembly of FIG. 4A.

FIG. 5 is an exploded perspective view of the example mainboard of FIGS. 4A and 4B.

FIG. 6 is another exploded perspective view of the mainboard of FIGS. 4A and 4B.

FIG. 7 is an exploded perspective view of the modular titer plate assembly of FIG. 1 with retainers.

FIG. 8 is a bottom perspective view of the example modular titer plate assembly of FIG. 1.

FIG. 9 is a cross-sectional view of adjacent wells of the example modular titer plate assembly of FIG. 1.

FIG. 10 is a graph of example signals generated by the example modular titer plate assembly of FIG. 1.

FIG. 11 is a block diagram for an example system that includes the example modular titer plate assembly of FIG. 1.

### DETAILED DESCRIPTION

Electro-chemical analysis capabilities can be added to a titer plate by adding electrodes and/or sensing electronics to the wells of the titer plate. However, titer plates are generally discarded after use, so adding sensing and readout/communication electronics to each well of a titer plate (e.g., 24, 48, 96 or more wells) can substantially increase the cost of titer plate replacement. In some titer plate applications, sensing of a parameter (e.g., pH) may be implemented using a reference electrode. Discrete reference electrodes are costly, and inclusion of a reference electrode per well substantially increases cost. Some systems employ a titer plate robot that sequentially applies a reference electrode to each well, thereby reducing electrode cost. However, moving the reference electrode from well to well increases the risk of contamination.

The modular titer plate assembly described herein includes sensing electronics to provide “lab-on-chip” functionality, and reduces the costs associated with titer plate replacement and use of per-well reference electrodes. The modular title plate assembly includes a multi-well plate, a sensor assembly, and a mainboard. The sensor assembly is detachably mounted to the multi-well plate, and includes sensor electronics for each well of the multi-well plate. The mainboard is detachably mounted to the sensor assembly, and includes communication and/or processing electronics coupled to the sensor electronics of the sensor assembly. The replacement cost of the modular titer plate is reduced by allowing for reuse of the sensor assembly and the mainboard while the multi-well plate may be replaced or cleaned. Also, the detachability of the mainboard and the sensor assembly from the multi-well plate can also facilitate testing, diagnostics, cleaning of the multi-well plate, and maintenance of the sensor electronics of the sensor assembly and of the communication and processing electronics of the mainboard.

The modular titer plate assembly described herein can also facilitate electro-chemical analysis. Specifically, the modular titer plate assembly includes channels between adjacent wells. Each channel can form a salt bridge between the respective wells. The salt bridge can support differential sensing, which can eliminate the need of reference electrodes.

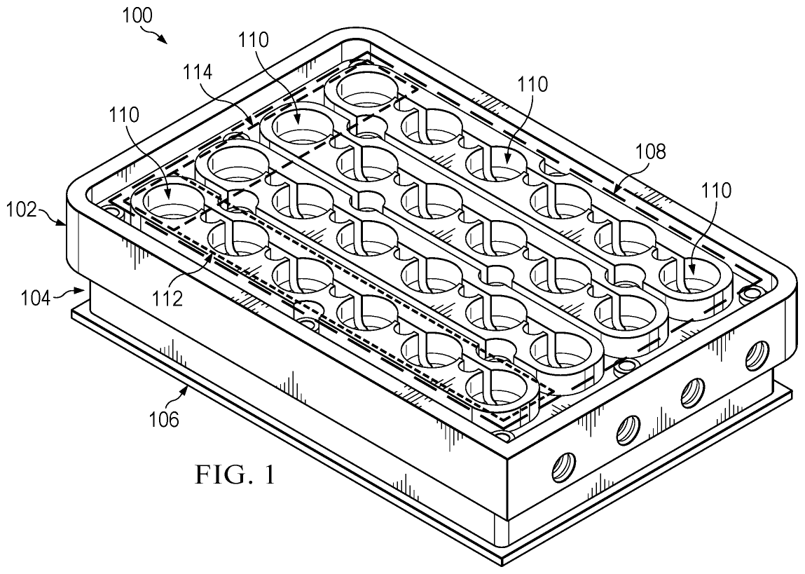

FIG. 1 is a perspective view of an example modular titer plate assembly 100. The modular titer plate assembly 100 includes a multi-well plate 102, a sensor assembly 104, and a mainboard 106. The sensor assembly 104 is detachably mounted to sensor assembly 104, and the mainboard 106 is detachably mounted to the sensor assembly 104. The multi-well plate 102 includes a two-dimensional array 108 of wells 110 arranged as rows 112 and columns 114.

The sensor assembly 104 includes electronic sensors (e.g., a sensor integrated circuit) coupled to the bottom of each well 110. The electronic sensors may include a pH sensor (e.g., an ion sensitive field effect transistor), a conductivity sensor, an oxygen sensor, a temperature sensor, and/or other sensors measuring a parameter of a liquid contained within the well.

The mainboard 106 is detachably mounted to the sensor assembly 104, and includes communication circuitry that is coupled to the electronic sensors of the sensor assembly 104. The communication circuitry receives measurement signals from the electronic sensors of the sensor assembly 104, and transfers the measurement signals to a computing device external to the modular titer plate assembly 100. Various examples communication circuitry may be provided in examples of the modular titer plate assembly 100. For example, the communication circuitry may include a microcontroller coupled to each of the electronic sensors of the sensor assembly 104, where the microcontroller processes the measurement signals received from the electronic sensors, and transmits the measurement signals to the external computing device via a digital communication interface (e.g., universal serial bus (USB)). In another example, the communication circuitry includes a switch network that selectively connects each of the electronic sensors to the external computing device. The switch network may include relays or semiconductor switches.

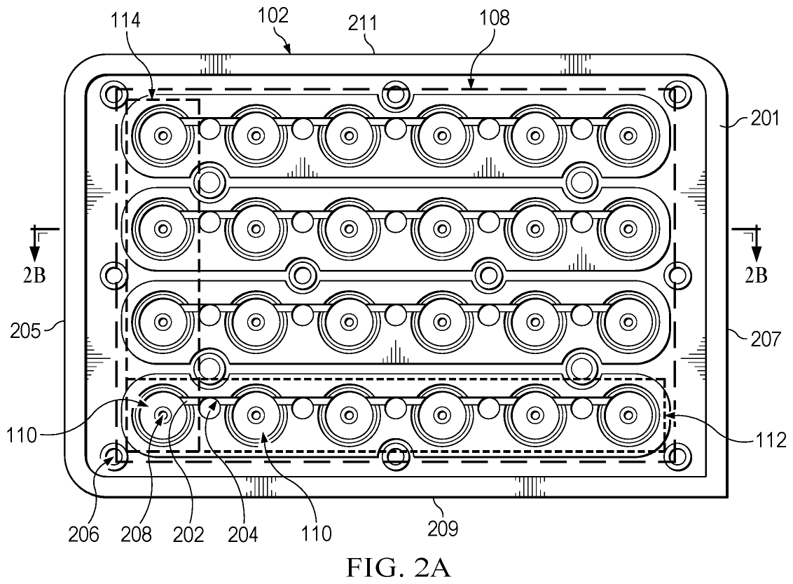

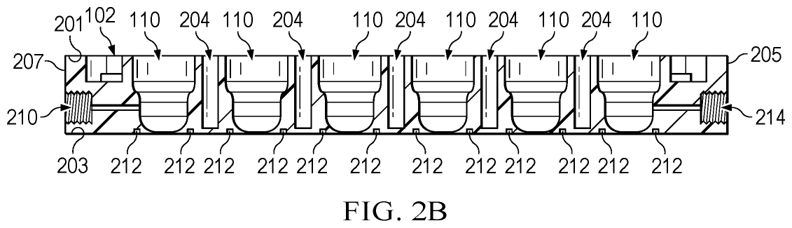

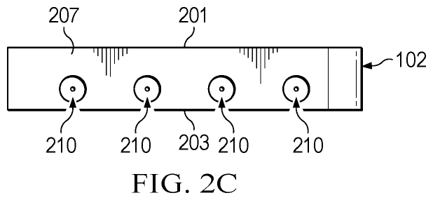

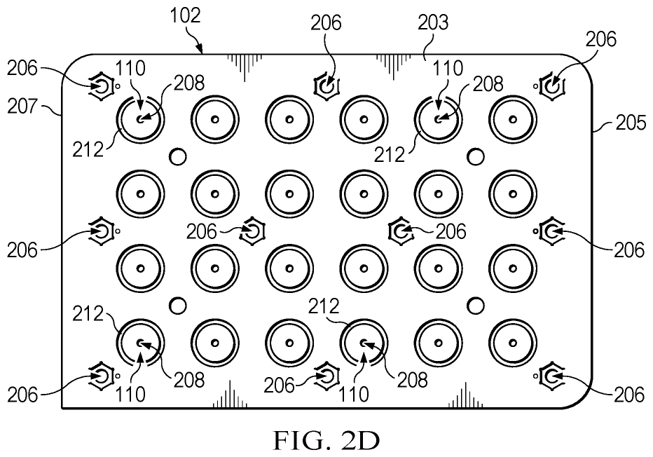

FIG. 2A is a top view of an example multi-well plate 102. The multi-well plate 102 is illustrated, in FIG. 2A, as including 24 wells 110 arranged as a two-dimensional array 108 of four rows 112 (each row including 6 wells 110) and 6 columns 114 (each column including 4 wells). The rows 112 extend from side 205 to side 207 of the multi-well plate 102, and the columns 114 extend from side 209 to side 211 of the multi-well plate 102. Other examples of the multi-well plate 102 may include a different number of wells, a different number of rows and columns, and/or a different number of wells per row or column. The bottom of each well 110 includes an opening 208 for transferring liquid from the well 110 to the electronic sensors of the sensor assembly 104.

Each row 112 includes a channel 202 coupled between adjacent wells 110. The channel 202 may provide a salt bridge between the adjacent wells 110. For example, the channel 202 may receive an electrolyte (e.g., potassium chloride, potassium nitrate, sodium chloride, etc.) via a paper, fiber, gel, or other medium. The salt bridge prevents the flow of liquid between the adjacent wells 110, and allows diffusive ion flow between the adjacent wells 110, creating an electrical connection between the electrochemical cells in the adjacent wells 110. The channel 202 includes a plug port 204. The plug port 204 allows a plug (e.g., a rubber tube) to be inserted in the channel 202. The plug blocks movement of liquid between the adjacent wells 110 when no salt bridge exists to electrically isolate between the adjacent wells 110, and to block liquid from flowing between the adjacent wells 110.

The multi-well plate 102 may also include passages 206 for passing a retainer, such as a bolt or a screw, through the multi-well plate 102 to the sensor assembly 104. The retainer fastens the multi-well plate 102 to the sensor assembly 104, and aligns the wells 110 of the multi-well plate 102 with the electronic sensors of the sensor assembly 104. Some examples of the multi-well plate 102 may lack the passages 206. In those examples, the multi-well plate 102 may include magnets or other fasteners (not shown in the figures) to align and couple with the sensor assembly 104.

FIG. 2B is a cross-sectional view of the multi-well plate 102 taken along plane 2B-2B shown in FIG. 2A. FIG. 2B shows that multi-well plate 102 includes an inlet port 214 and an outlet port 210. The inlet port 214 is coupled to a well 110 at one end of a row 112, and the outlet port 210 is coupled to a well 110 at an opposite end of the row 112. The inlet port 214 and the outlet port 210 may be utilized to pass liquid through the wells 110 of the row 112, for cleaning or other purposes. The multi-well plate 102 also includes a groove 212 in the bottom surface 203 of the multi-well plate 102 around each well 110. A groove 212 may hold a seal ring (an O-ring) for sealing an interface between the bottom surface 203 of the multi-well plate 102 and the sensor assembly 104.

FIG. 2C is an end view of the multi-well plate 102. FIG. 2C shows one instance of the outlet port 210 for each row 112 of the multi-well plate 102. The multi-well plate 102 also includes one instance of the inlet port 214 for each row 112 of the multi-well plate 102.

FIG. 2D is a bottom view of the multi-well plate 102. FIG. 2D shows the opening 208 of each well 110, and the groove 212 surrounding each well 110.

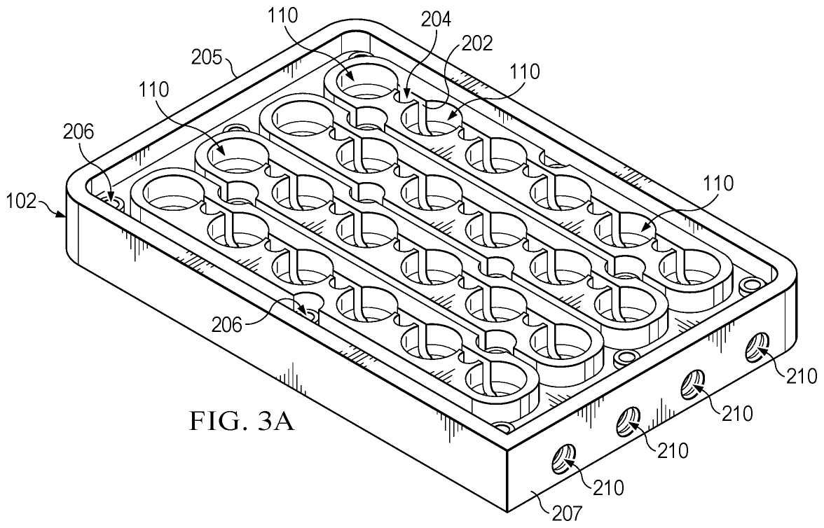

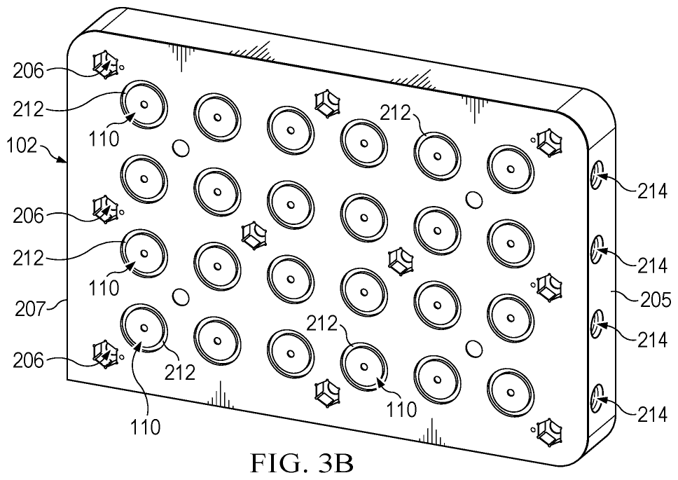

FIG. 3A is a top perspective view of the multi-well plate 102.

FIG. 3B is a bottom perspective view of the multi-well plate 102.

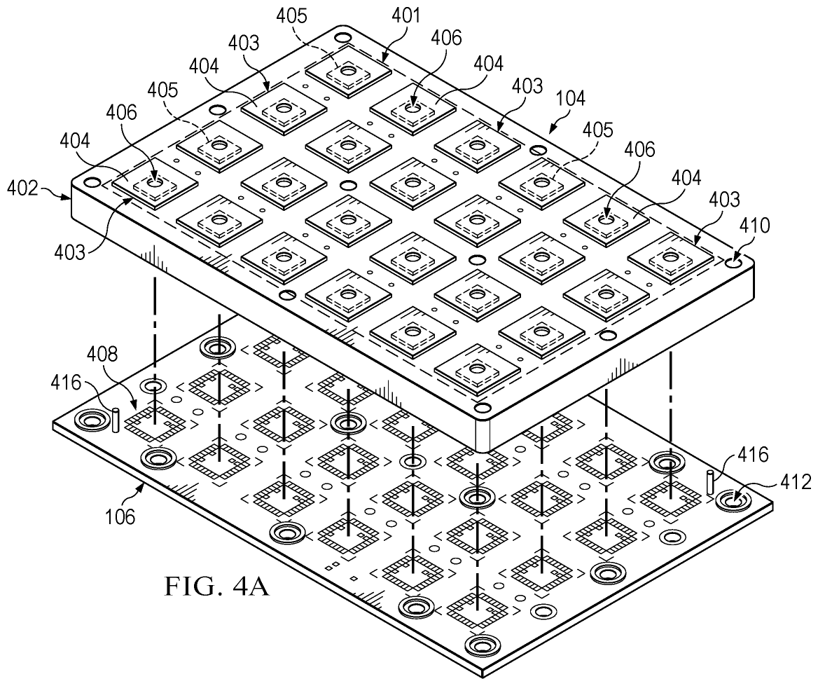

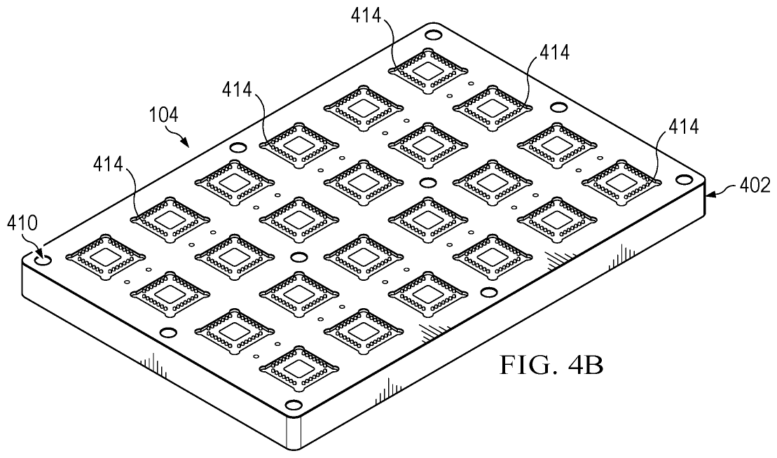

FIG. 4A is an exploded perspective view of an example sensor assembly 104 and an example mainboard 106 of the modular titer plate assembly 100. The sensor assembly 104 includes a base 402 and a two-dimensional array 401 of electronic sensors 403 arranged in rows and columns mounted on the base 402. The base 402 may be made of fiber-reinforced plastic or other material. Each electronic sensor 403 of the two-dimensional array 401 of electronic sensors 403 interfaces with a respective well 110 in the two-dimensional array 108 of the multi-well plate 102. Each electronic sensor 403 includes a printed circuit board 404 and a sensor integrated circuit 405.

An opening 406 in the printed circuit board 404 allows the well 110 to interface with the sensor integrated circuit 405 mounted on the bottom-side of the printed circuit board 404. The base 402 includes mounting holes 410 configured to receive bolts or screws that align the electronic sensors of the sensor assembly 104 with the wells of the multi-well plate 102, and to mount the sensor assembly 104 to the multi-well plate 102. The bolts or screws can also be removed from the mounting holes 410 to detach the sensor assembly 104 from the multi-well plate 102. The sensor assembly 104 also includes pins or contacts (e.g., spring-loaded pogo-pins) that provide electrical connections between the electronic sensors 403 and the mainboard 106.

The mainboard 106 includes sets of contacts 408. The sets of contacts 408 engage pins (e.g., spring-loaded pins) of the sensor assembly 104 to provide electrical connections between the mainboard 106 and the sensor assembly 104 for transmission of signals and power. In some examples of the mainboard 106, the sets of contacts 408 are arranged in a two-dimensional array, with a set of the contacts 408 coupled to a respective electronic sensor 403 of the sensor assembly 104. FIG. 4B is a perspective view of a bottom of the sensor assembly 104 showing the spring-loaded pins 414 that engage the contacts 408.

The mainboard 106 may include microcontrollers or switching circuits associated with contacts 408. For example, a microcontroller or switching circuit may be coupled to each set of the contacts 408. Some examples of the mainboard 106 include mounting holes 412 configured to receive bolts or screws that pass through the multi-well plate 102 and the sensor assembly 104 to mount the mainboard 106 to the sensor assembly 104 and the multi-well plate 102. The mainboard 106 may also be aligned with the sensor assembly 104 by the bolts or screws. In some examples, the mounting hole 412 may include a threaded socket configured to engage a screw to fasten/mount the mainboard 106 to the sensor assembly 104. Some examples of the mainboard 106 may also include two or more pins 416, each pin 416 configured to engage a respective socket of the sensor assembly 104 to facilitate alignment between the sensor assembly 104 and the mainboard 106.

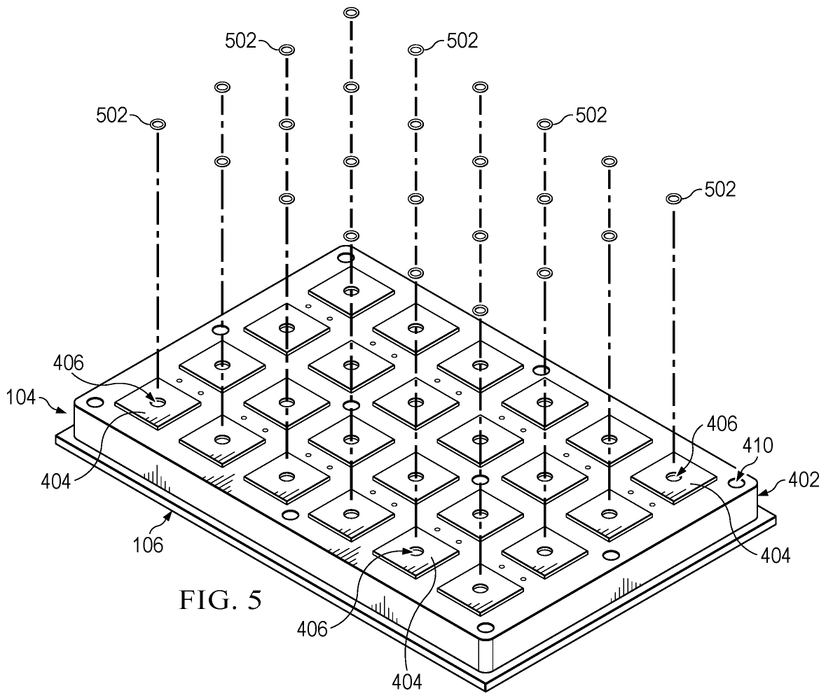

FIG. 5 is an exploded perspective view of the mainboard 106 coupled to the sensor assembly 104. Sensor assembly 104 can include a seal ring 502 in the opening 406 of each printed circuit board 404 to seal the interface between the well 110 and the sensor integrated circuit mounted on the printed circuit board 404. Such arrangements can improve seal engagement of the sensor assembly 104 to the wells 110.

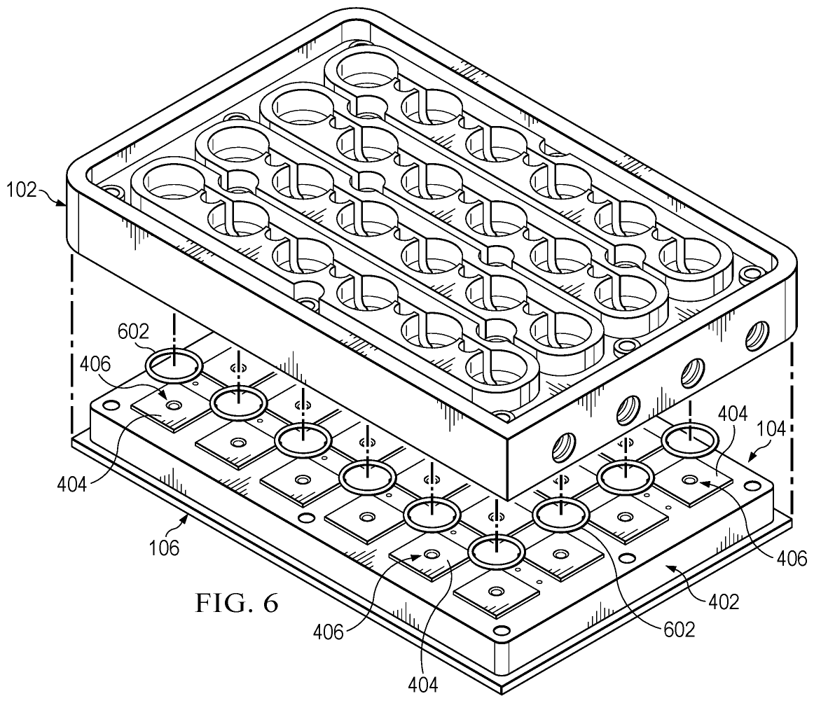

FIG. 6 is another exploded perspective view of the multi-well plate 102, the sensor assembly 104 and the mainboard 106. Modular titer plate assembly 100 can include a seal ring 602 in the groove 212 around each well 110 of the well plate 102 to engage the printed circuit board 404. The seal rings 602 seal the interface between the multi-well plate 102 and the printed circuit board 404.

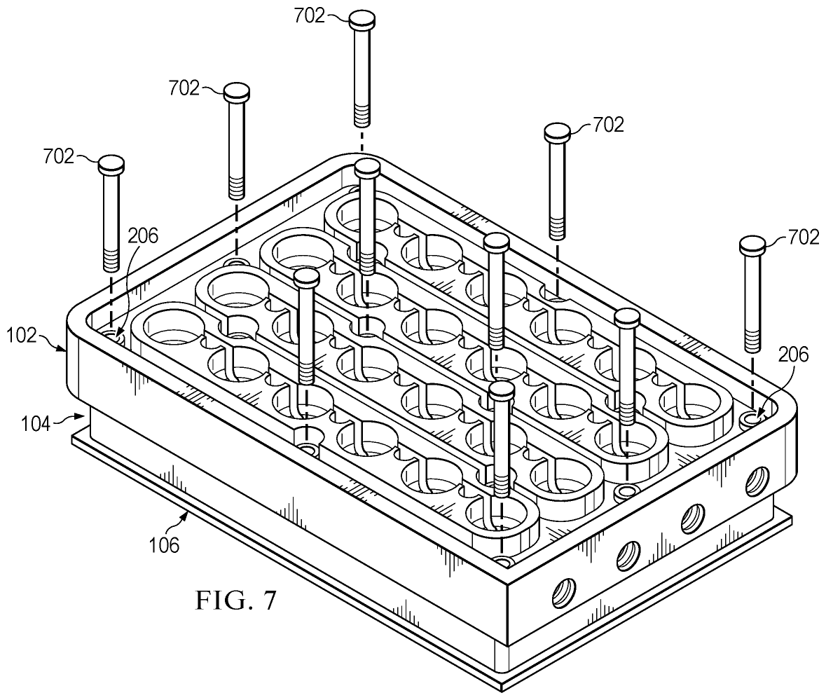

FIG. 7 is an exploded perspective view of the multi-well plate 102, the sensor assembly 104, and the mainboard 106. The modular titer plate assembly 100 can include retainers 702 (e.g., bolts or screws) in the passages 206 of the multi-well plate 102. The retainers 702 can also pass through the sensor assembly 104 and the mainboard 106 to align and fasten together the multi-well plate 102, the sensor assembly 104, and the mainboard 106. The retainers 702 can be removed to separate the mainboard 106 from the sensor assembly 104, and to separate the sensor assembly 104 from the multi-well plate 102. Some examples of the multi-well plate 102, the sensor assembly 104, and the mainboard 106 may include magnets or another mechanism (not shown in the figures) to align and fasten together the multi-well plate 102, the sensor assembly 104, and the mainboard 106, which also allow the separation of the mainboard 106 from the sensor assembly 104 and the separation of the sensor assembly 104 from the multi-well plate 102.

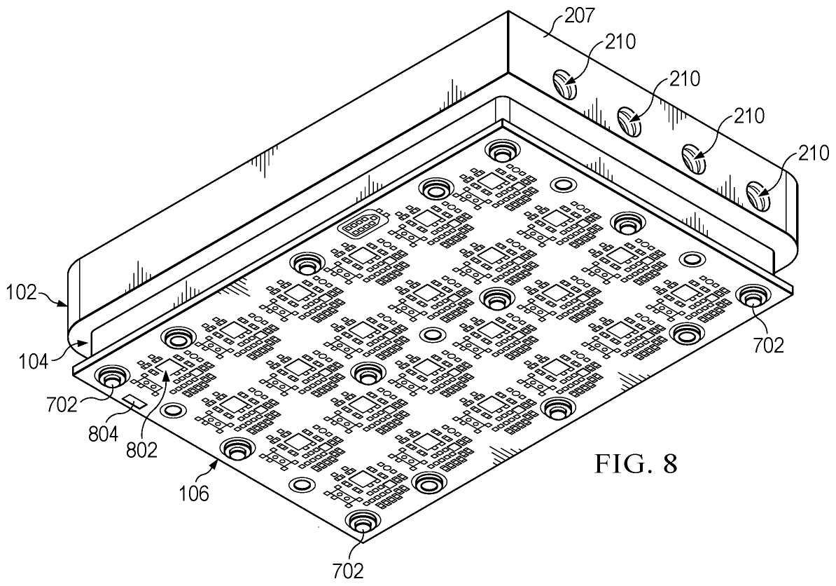

FIG. 8 is a bottom perspective view of the modular titer plate assembly 100. The bottom side of the mainboard 106 includes interface circuitry 802 that receives the measurement signals from the sensor assembly 104. The bottom side of the mainboard 106 may also include an electrical connector 804 for connecting the mainboard 106 to an external computing device and power source. The mainboard 106 may communicate the outputs of the sensor assembly 104 (e.g., measurement signals received from the sensor assembly 104) to the external computing device via the electrical connector 804. The mainboard 106 and the sensor assembly 104 may also receive power via the electrical connector 804. In some examples of the mainboard 106, the electrical connector 804 may be a USB-C connector or other type of serial communication bus connector. Some examples of the mainboard 106 may include circuitry configured to provide wireless communication of measurement signals to an external computing device via BLUETOOTH, WI FI, or other wireless communication protocol. The mainboard 106 may include various electronic components (e.g., passive components, logic circuits, etc.) that support the operation of the interface circuitry 802. The interface circuitry 802 may be implemented using a microcontroller in some implementations of the mainboard 106.

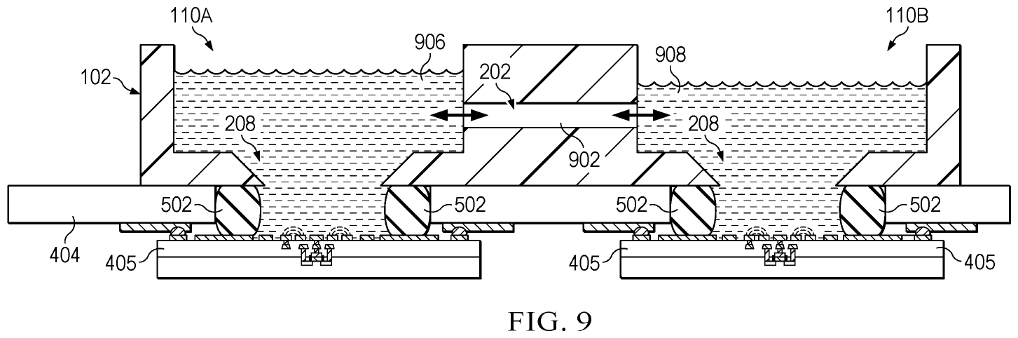

FIG. 9 is a cross-sectional view of adjacent wells 110 of the modular titer plate assembly 100. The two wells 110 are connected by a salt bridge 902 formed in the channel 202. The multi-well plate 102 is coupled to the sensor assembly 104. In the sensor assembly 104, the sensor integrated circuits 405 are mounted on the bottom side of the printed circuit board 404. The seal ring 502 seals the interface of the multi-well plate 102 and the printed circuit board 404. The liquid 906, 908 contained in the wells 110 pass through the opening 208 to a sensing surface (e.g., electrodes) of the sensor integrated circuits 405 for measurement. In some examples, the sensor assembly 104 may include a membrane over the sensing surface of the sensor integrated circuits 405.

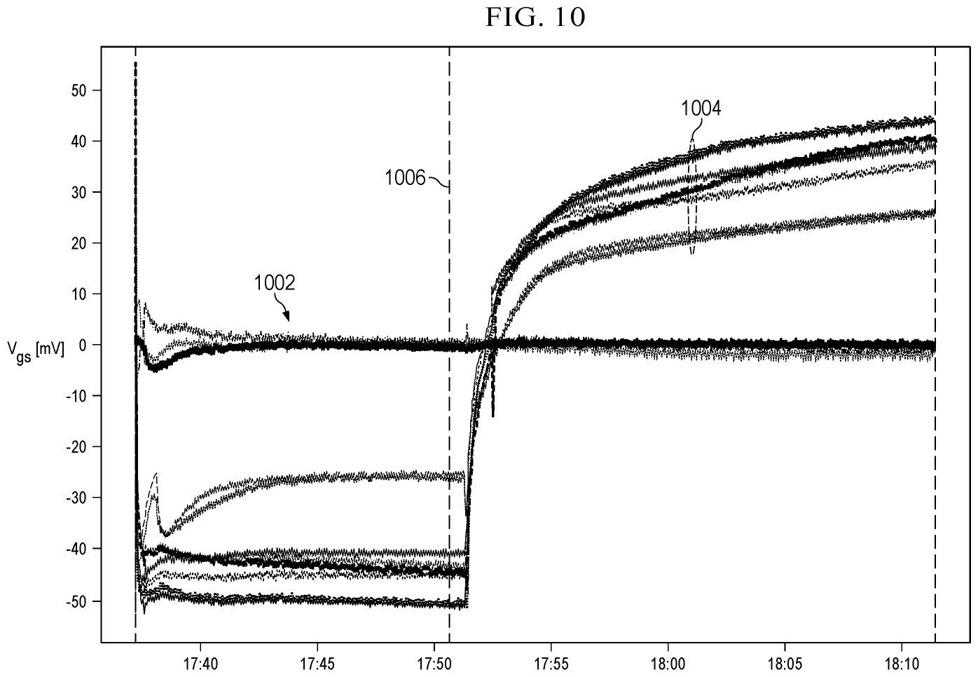

FIG. 10 is a graph of example voltage signals generated by the modular titer plate assembly 100. The voltage signals shown in FIG. 10 represent a pH measurement by the sensor integrated circuits 405. The voltage signals 1002 are measurements taken from reference wells. The voltage signals 1004 are measurements take from test wells. At time 1006, a reaction chemical is introduced to the test wells, and the pH of liquid in the test wells changes. The change in measured voltage is representative of the change in pH.

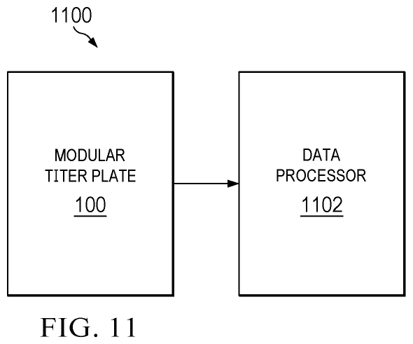

FIG. 11 is a block diagram for an example system 1100. The 1100 includes the modular titer plate assembly 100 and a data processor 1102. The data processor 1102 is communicatively coupled to the modular titer plate assembly 100 for receipt of measurement values output by the modular titer plate assembly 100. For example, the data processor 1102 may be coupled to the modular titer plate assembly 100 via USB or other communication interface. The data processor 1102 may be any computing device capable of receiving the measurement signals output by the modular titer plate assembly 100. For example, the data processor 1102 may be a laptop computer, a desktop computer, a rackmount computer, a microcontroller, a data acquisition system, or other electronic device. The data processor 1102 may be configured to process, display, and/or store measurement values received from the modular titer plate assembly 100.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground voltage potential” and/or “ground” in this description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter, or, if the value is zero, a reasonable range of values around zero.

Modifications are possible in the described embodiments, and other embodiments are possible, within the scope of the claims.

What is claimed is:

1. A modular titer plate assembly, comprising:
a multi-well plate including a two-dimensional array of wells;
a sensor assembly detachably mounted to the multi-well plate, in which the sensor assembly includes a two-dimensional array of sensors aligned with the two-dimensional array of wells; and
a mainboard detachably mounted to the sensor assembly.

2. The modular titer plate assembly of claim 1, wherein:
the two-dimensional array of wells includes a row of wells; and
the multi-well plate includes channels, in which each channel couples between respective adjacent wells of the row of wells.

3. The modular titer plate assembly of claim 2, wherein the multi-well plate includes, in each channel, a plug port configured to receive a plug to block liquid from flowing between the respective adjacent wells.

4. The modular titer plate assembly of claim 2, wherein the multi-well plate includes:
an inlet port at first end of the row of wells; and
an outlet port at a second end of the row of wells.

5. The modular titer plate assembly of claim 1, wherein:
the two-dimensional array of sensors is aligned with the two-dimensional array of wells; and
the two-dimensional array of sensors includes at least one of a pH sensor, a conductivity sensor, an oxygen sensor, or a temperature sensor.

6. The modular titer plate assembly of claim 1, further comprising a removable retainer configured to align sensors of the sensor assembly with wells of the multi-well plate, and to mount the sensor assembly to the multi-well plate.

7. The modular titer plate assembly of claim 1, further comprising seal rings coupled between wells of the multi-well plate and the sensor assembly.

8. The modular titer plate assembly of claim 1, wherein the mainboard includes contacts, and the sensor assembly includes spring-loaded pins configured to engage the contacts and to provide electrical connections between the sensor assembly and the mainboard.

9. The modular titer plate assembly of claim 1, wherein the mainboard includes interface circuitry configured to provide measurement signals based on outputs of the sensor assembly.

10. The modular titer plate assembly of claim 9, wherein the interface circuitry includes an array of microcontrollers, each microcontroller of the array of microcontrollers configured to process measurements from a respective well of the two-dimensional array of wells of the multi-well plate.

11. A modular titer plate assembly, comprising:
a multi-well plate including:
a two-dimensional array of wells including:
a row of wells; and
channels, in which each channel couples between respective adjacent wells of the row of wells and configured to allow liquid to flow between the adjacent wells.

12. The modular titer plate assembly of claim 11, wherein the multi-well plate includes, in each channel, a plug port configured to receive a plug to block liquid from flowing between the respective adjacent wells.

13. The modular titer plate assembly of claim 11, wherein the multi-well plate includes:
an inlet port at first end of the row of wells; and
an outlet port at a second end of the row of wells.

14. The modular titer plate assembly of claim 11, further comprising:
a sensor assembly detachably mounted to the multi-well plate, in which the sensor assembly includes a two-dimensional array of sensors aligned with the two-dimensional array of wells; and
a mainboard detachably mounted to the sensor assembly.

15. The modular titer plate assembly of claim 14, wherein:
the two-dimensional array of sensors is aligned with the wells of the multi-well plate; and
the two-dimensional array of sensors includes at least one of: a pH sensor, a conductivity sensor, an oxygen sensor, or a temperature sensor.

16. The modular titer plate assembly of claim 15, further comprising a removable retainer configured to align the sensors of the sensor assembly with the wells of the multi-well plate, and to mount the sensor assembly to the multi-well plate.

17. The modular titer plate assembly of claim 14, further comprising seal rings coupled between wells of the multi-well plate and the sensor assembly.

18. The modular titer plate assembly of claim 14, wherein the mainboard includes contacts, and the sensor assembly includes spring-loaded pins configured to engage the contacts and to provide electrical connections between the sensor assembly and the mainboard.

19. The modular titer plate assembly of claim 14, wherein the mainboard includes interface circuitry configured to provide measurement signals based on outputs of the sensor assembly.

20. A system, comprising:
a modular titer plate assembly including:
a multi-well plate including a two-dimensional array of wells;
a sensor assembly detachably mounted to the multi-well plate, in which the sensor assembly includes a two-dimensional array of sensors aligned with the two-dimensional array of wells, the two-dimensional array of sensors including at least one of: a pH sensor, a conductivity sensor, an oxygen sensor, or a temperature sensor; and
a mainboard detachably mounted to the sensor assembly; and
a data processor communicatively coupled to the modular titer plate assembly.

21. The system of claim 20, wherein:
the two-dimensional array of wells includes a row of wells; and
the multi-well plate includes:
channels, in which each channel couples between respective adjacent wells of the row of wells and configured to allow liquid to flow between the adjacent wells;
a plug port in each channel, each plug port configured to receive a plug to block liquid from flowing between the respective adjacent wells;
an inlet port at first end of the row of wells; and
an outlet port at a second end of the row of wells.

22. The system of claim 20, wherein the modular titer plate assembly further comprises:
a removable retainer configured to align sensors of the sensor assembly with wells of the multi-well plate, and to mount the sensor assembly to the multi-well plate;
seal rings coupled between wells of the multi-well plate and the sensor assembly; and
spring-loaded pins configured to provide electrical connections between the sensor assembly and the mainboard.

23. The system of claim 20, wherein the mainboard includes interface circuitry configured to provide measurement signals based on outputs of the sensor assembly to the data processor.
